(19) United States
(12) Patent Application Publication
(10) Pub. No.: US 2009/0245292 A1
(43) Pub. Date: Oct. 1, 2009

(54) CLOCK RECOVERY APPARATUS AND METHOD

(75) Inventor: Yohei KOGANEI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/399,143

(22) Filed: Mar. 6, 2009

(30) Foreign Application Priority Data
Mar. 31, 2008 (JP) 2008-090661

(51) Int. Cl. H04J 3/04

(52) U.S. Cl. 370/535

(57) ABSTRACT

A clock recovery apparatus allows that a clock of data is transparent before and after a relay. A clock recovery apparatus for performing clock recovery from a received signal, the clock recovery apparatus receiving a signal transmitted from a transmission apparatus converting a signal having a first signal-format with a first clock frequency into a signal having a second signal-format and transmitting the signal to the clock recovery apparatus in accordance with a second clock frequency, the clock recovery apparatus includes a signal processing section for converting the received signal into a signal having the first signal-format, and a clock recovery section for recovering the first clock frequency on a basis of a cycle produced by counting data of the signal obtained by the signal having the first signal-format processing section in a certain number.

### CROSS-REFERENCE TO RELATED APPLICATIONS

This application is based upon and claims the benefit of priority of the prior Japanese Patent Application No. 2008-090661, filed on Mar. 31, 2008, the entire contents of which are incorporated herein by reference.

### FIELD

The embodiments discussed herein are related to a clock recovery apparatus and method, a transmission apparatus, and a communication system. The embodiments are sometimes used in a transmission apparatus which multiplexes or demultiplexes a plurality of tributary signals in communications, such as Gigabit Ethernet (registered trademark), for example.

### BACKGROUND

FIG. 7 is a block diagram illustrating an example of a communication system.

In the communication system shown in FIG. 7 as an example, a transmission apparatus (time-division multiplexer) 100 of a transmission relay station receives signals (tributary signals #1 to #n) from a plurality of tributary apparatuses (not shown in the figure) #1 to #n (n is an integer of 2 or more), the received signals are subjected to signal processing by the corresponding signal processing sections 101, then are subjected to time-division multiplexing by a multiplexing section 102, and are transmitted onto a transmission line 300.

The signal processing in the signal processing section 101 includes, for example, addition processing of added data, such as overhead information, clock (clock frequency) transfer processing, etc.

The transfer-destination clock is in synchronous with a clock (multiplexing clock) of a common internal oscillator (clock source) 103 in the time-division multiplexer 100 so as to perform time-division multiplexing for the multiplexing section 102. By the transfer to this clock, original clock components of individual tributary signals are eliminated.

On the other hand, in a transmission apparatus (time-division demultiplexer) 200 of a receiving relay station, a demultiplexer 104 separates the time-division multiplexed signal received from the transmission line 300 for each tributary signal. Each of the separated tributary signals is subjected to signal processing by a corresponding signal processing section 105.

The signal processing section 105, for example, removes overhead information added in the transmission relay station (time-division multiplexer) 100, performs signal processing, such as transferring to a clock (tributary clock) synchronized with a clock of the transmission-destination tributary apparatuses #1′ to #n′, and transmits a tributary signal #n′ to a tributary apparatus #n′.

The tributary clock is generated by a common internal oscillator (clock source) 106 in the receiving relay station 200.

Japanese Laid-open Patent Publication No. 2000-36797 discloses to provide a transmission system configuring the multilink that combines the transmission paths having any transmission capacity provided by the SONET.

A difference (deviation) may arise in frequency among a tributary signal #n′ for each tributary #i′ (i=1 to n) after the clock transfer. If the tributary signal #n′ conforms to, for example, Ethernet (registered trademark), it is possible to absorb the frequency deviation by changing an inter frame gap (IFG) of media access control (MAC) frame.

However, there is an upper limit for absorbing the frequency deviation. Thus, there are cases where it is desirable not to change the frequency or IFG of a tributary signal by a relay station depending on a communication with each tributary (client) apparatus.

In the above-described example, in the receiving relay station 200, clock transfer of each tributary signal is performed using an internal clock which is not in synchronous with the frequency and the phase of each tributary signal clock eliminated in the multiplexing process by the transmission relay station 100. Accordingly, the clock of each tributary signal is not transmitted through the relay station transparently.

### SUMMARY

According to an aspect of an embodiment, a clock recovery apparatus for performing clock recovery from a received signal, the clock recovery apparatus receiving a signal transmitted from a transmission apparatus converting a signal having a first signal-format with a first clock frequency into a signal having a second signal-format and transmitting the signal to the clock recovery apparatus in accordance with a second clock frequency, the clock recovery apparatus includes a signal processing section for converting the received signal into a signal having the first signal-format, and a clock recovery section for recovering the first clock frequency on a basis of a cycle produced by counting data of the signal having the first signal-format obtained by the signal processing section in a certain number.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a communication system according to an embodiment;

FIG. 2 is a block diagram illustrating an example of a configuration of a signal processing section of the communication system shown in FIG. 1;

FIG. 3 is a block diagram illustrating an example of a configuration of a signal-processing/clock-recovery section of the communication system shown in FIG. 1;

FIG. 4 is a block diagram illustrating an example of a configuration of the signal processing section shown in FIG. 3;

FIG. 5 is a schematic diagram illustrating an example of a mode (state) transition of a PLL circuit shown in FIG. 3.

FIG. 6 is a timing chart illustrating an operation of the communication system shown in FIG. 1 as an example; and

FIG. 7 is a block diagram illustrating an example of a related-art communication system.

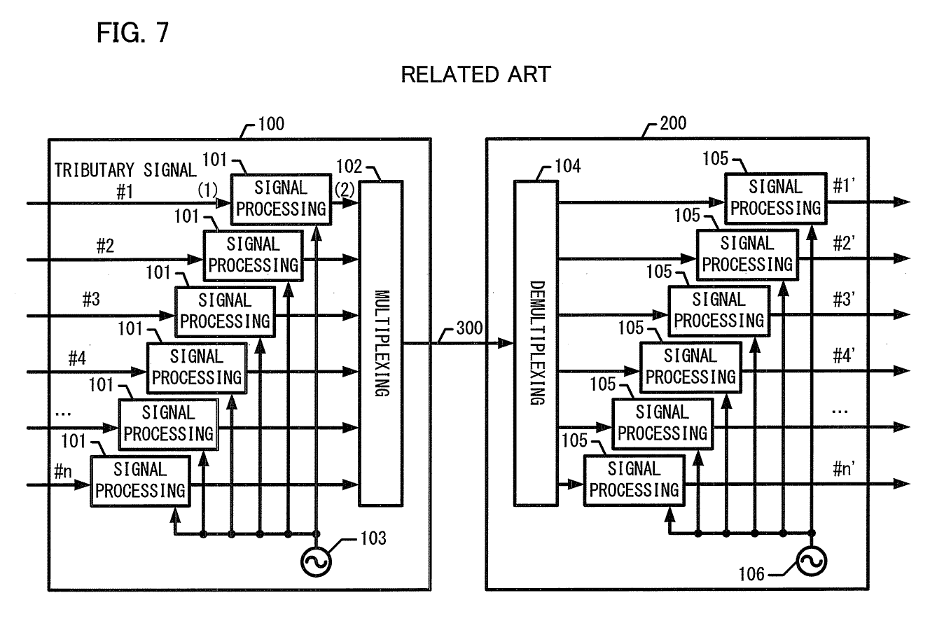

### DESCRIPTION OF EMBODIMENT

In the following, a description will be given of an embodiment with reference to the drawings.

### [1] Embodiment

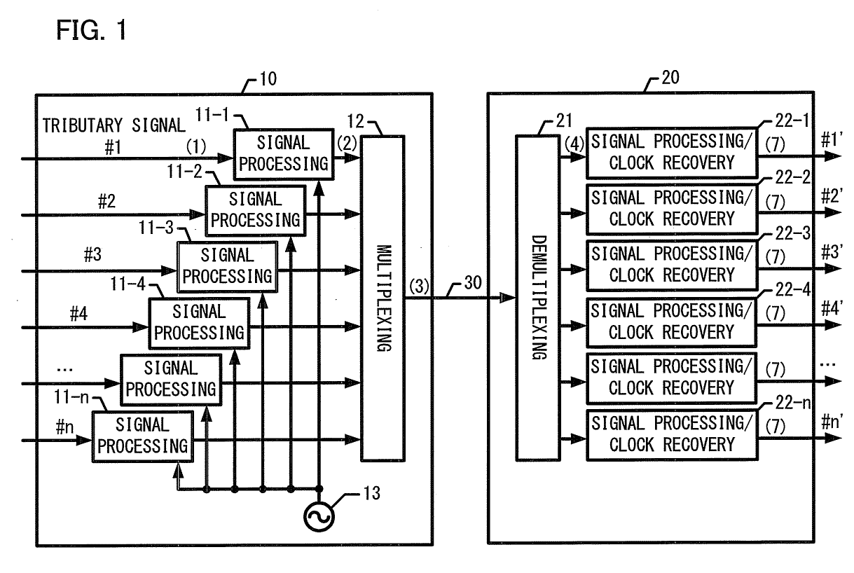

FIG. 1 is a block diagram illustrating an example of a configuration of a communication system according to an embodiment. The system shown in FIG. 1 includes, for example, a time-division multiplexing apparatus 10 (in the following, referred to as a transmission apparatus 10) as a first transmission apparatus of a transmission relay station, and a time-division demultiplexing apparatus 20 (in the following, referred to as a receiving apparatus 20) as a second transmission apparatus of a receiving relay station. The transmission apparatus 10 is connected to the receiving apparatus 20 through a transmission line (relay line) 30. Onto the transmission line 30, it is transmitted signals which constitute, for example, a synchronous digital hierarchy (SDH), a synchronous optical network (SONET), a wavelength division multiplexing (WDM) network, or an optical transport network (OTN).

The transmission apparatus 10 receives signals from a plurality of transmission-source tributary apparatuses (not shown in the figure) #1 to #n, performs time-division multiplexing on the signals into a predetermined transmission frame in SDH/SONET, etc., and transmits the signals onto the transmission line 30. In this regard, a tributary signal #i received from a transmission-source tributary apparatus #i has a clock (first clock frequency) synchronized with a transmission clock of the transmission-source tributary apparatus #i.

The receiving apparatus 20 separates tributary signals from the time-division multiplexed signal received through the transmission line 30, and transmits the signals to the destination tributary apparatuses #1′ to #n′. At that time, the receiving apparatus 20 recovers the clock of the tributary signal #i received by the transmission apparatus 10 on the basis of the received signal through the transmission line 30, and transmits the signals to the destination tributary apparatuses #1′ to #n′ in accordance with the recovered clock frequency.

The tributary signal is a signal for a protocol, such as Gigabit Ethernet, asynchronous transfer mode (ATM) network, Fiber Channel (FC), etc. The tributary signal corresponds to a transmission signal or a receiving signal of a client supporting the protocol. Thus, it is possible to communicate (transmit information) between a tributary apparatus #i as a transmission source (client) and a tributary apparatus #i′ as a destination (client).

The transmission apparatus 10 includes, for example, signal processing sections 11-1 to 11-n corresponding with each transmission-source tributary apparatus #i, a multiplexing section 12, and an internal oscillator (clock source) 13. On the other hand, the receiving apparatus 20 includes, for example, a demultiplexing section 21, signal-processing/clock-recovery sections 22-1 to 22-n corresponding with each transmission-destination tributary apparatus #i.

In the transmission apparatus 10, the signal processing section 11-i performs predetermined signal processing on the tributary signal received from each transmission-source tributary apparatus #i. The signal processing includes, for example, addition processing of control information such as overhead information in accordance with a predetermined signal format (protocol), clock (clock frequency) transfer processing, etc. The transfer-destination clock is in synchronous with a clock (multiplexing clock component; a second clock frequency) of an internal oscillator 13 in order for the multiplexing section 12 to perform time-division multiplexing processing.

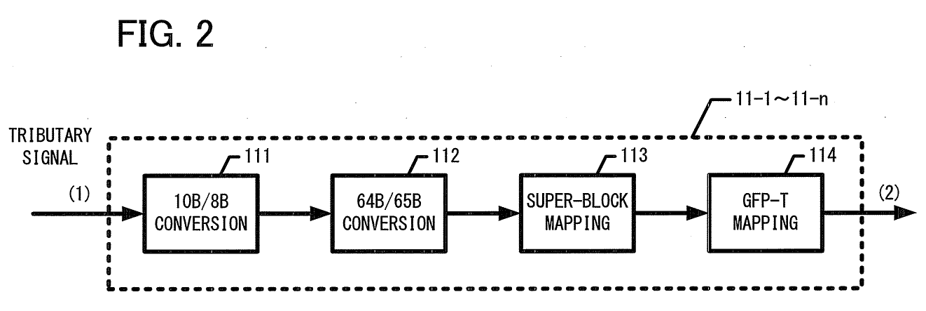

FIG. 2 illustrates an example of the signal processing section 11-i. The signal processing section 11-i shown in FIG. 2 illustrates an example of a configuration of the case where the receiving tributary signal is a Gigabit Ethernet signal. The signal processing section 11-i includes, for example, a 10B/8B conversion section 111, a 64B/65B conversion section 112, a super-block mapping section 113, and a GFP-T (Generic Framing Procedure—Transparent) mapping section 114.

The 10B/8B conversion section 111 deletes 2-bit control information added for each 10 bits by a client protocol from the received tributary signal, thereby decoding the signal into an 8-bit signal (10B/8B symbol).

The 64B/65B conversion section 112 adds 1-bit control information for each 8 bytes (64 bits) to the 10B/8B symbol obtained by the 10B/8B conversion processing, thereby encoding the symbol into a 65-bit signal (64B/65B block code).

The super-block mapping section 113 combines, for example, a plurality of pieces (for example, eight pieces) of 64B/65B block code signal obtained by the 64B/65B conversion section 112 to generate a signal (65-byte data+CRC16 data) called a super block.

The GFP-T mapping section 114 maps. (encapsulates) super blocks obtained by the super-block mapping section 113 for each certain number of blocks onto a payload of a GFP frame. By using a GFP (GFP-T) method in a transparent mode, it becomes possible to accommodate tributary signals in the transmission line (a relay line) 30 of SONET/SDH, OTN, etc.

In this regard, it is possible to adjust frequency deviation among each tributary signal #i, for example, by inserting empty data (padding) in the 64B/65B conversion section 112, or by inserting idle data in the GFP-T mapping section 114.

In FIG. 1, the multiplexing section 12 performs time-division multiplexing on the tributary signal having been subjected to the signal processing by each signal processing section 11-i, and transmits the signal onto the transmission line 30. For example, if the tributary signal is the Gigabit Ethernet signal and the transmission line 30 is a relay line of SDH/SONET, the multiplexing section 12 performs mapping (multiplexing) of the GFP frame generated by each signal processing section 11-i into an SDH/SONET transmission frame as an example of time-division multiplexed signal.

On the other hand, in the receiving apparatus 20, the demultiplexing section 21 separates the time-division multiplexed signal received through the transmission line 30 into each tributary signal before multiplexing, and the corresponding signal- processing/clock-recovery section 22-i receives the signal.

The signal-processing/clock-recovery section (clock recovery section) 22-i individually performs predetermined signal processing on the tributary signal output from the demultiplexing section 21 to reproduce the original tributary signal. At the same time, the signal-processing/clock-recovery section 22-i recovers the clock of the original tributary signal, which has been eliminated by the clock transfer processing in the transmission apparatus 10, and transmits the tributary signal to the tributary apparatus #i′ in synchronous with the recovered clock.

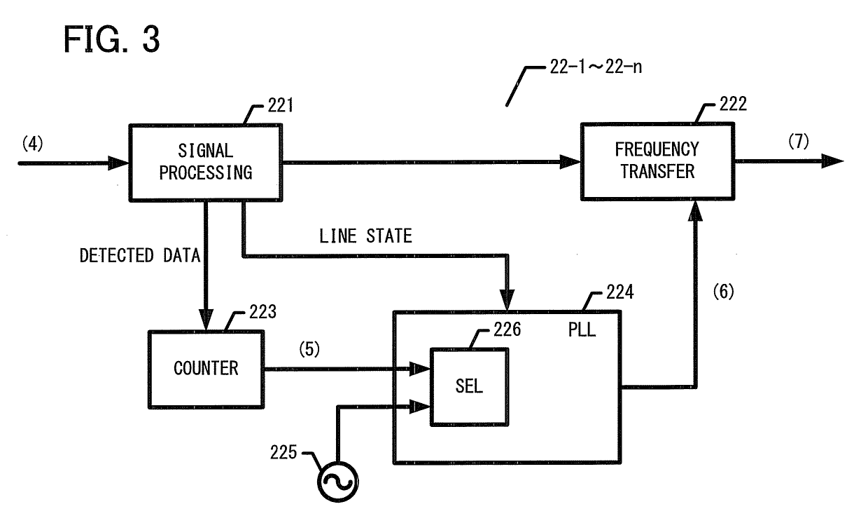

FIG. 3 illustrates an example of a configuration of the signal-processing/clock-recovery section 22-i shown in FIG. 1. The signal-processing/clock-recovery section 22-i shown in FIG. 3 includes a signal processing section 221, a frequency transfer section 222, a counter 223, a phase-locked-loop (PLL) circuit 224, and an internal oscillator (clock source) 225.

The signal processing section 221 deletes the additional information, such as overhead information added by the transmission apparatus 10 from the signal output from the demultiplexing section 21 to generate (reproduce) the data of the original tributary signal #i. The generated signal is output to the frequency transfer section 222.

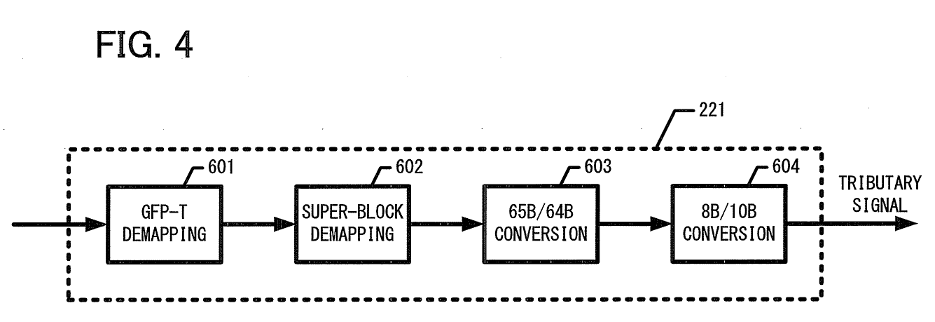

FIG. 4 illustrates an example of a configuration of the signal processing section 221 in the case where the tributary signal is the Gigabit Ethernet signal. The signal processing section 221 shown in FIG. 4 reproduces the original tributary signal #i by the opposite processing to the signal processing in the signal processing section 11-i shown in FIG. 2.

Thus, the signal processing section 221 includes, for example, a GFP-T demapping section 601, a super-block demapping section 602, a 65B/64B conversion section 603, and an 8B/10B conversion section 604.

The GFP-T demapping section 601 extracts the data (super block) mapped in the GFP payload from a GFP frame as an example of the tributary signal separated by the demultiplexing section 21.

The super-block demapping section 602 extracts a super block mapped in the GFP payload data extracted by the GFP-T demapping section 601.

The 65B/64B conversion section 603 deletes the 1-bit control information added for each 8 bytes (64 bits) by the transmission apparatus 10 (the signal processing section 11-i) from the super block extracted by the super-block demapping section 602 so as to generate a 64-bit signal (65B/64B block code).

The 8B/10B conversion section 604 generates (reproduces) the original tributary signal received by the transmission apparatus 10 from the transmission-source tributary #i by adding the 2-bit control signal deleted by the transmission apparatus 10 (the signal processing section 11-i) to the 65B/64B block code signal obtained by the 65B/64B conversion section 603.

In this regard, when the transmission apparatus 10 has performed insertion of padding in the 64B/65B conversion section 112 and insertion of idle data in the GFP-T mapping section 114 for the adjustment of the frequency deviation, the idle data is deleted by the GFP-T demapping section 601 and the padding is deleted by the 65B/64B conversion section 603.

In FIG. 3, the counter (N-cycle counter) 223 counts data of the original tributary signal obtained by the signal processing section 221 for each certain unit (interval), and outputs the detected signal (clock) for each N counts to a PLL circuit 224. For example, if the signal processing section 221 has a configuration shown in FIG. 4, the counter 223 counts the output data for each constant number (N) while the output of the 8B/10B conversion section 604 is effective, and outputs the clock for each N counts to the PLL circuit 224.

In this regard, a value of the N is determined on the basis of the data format of the signal processing by the transmission apparatus 10 (the signal processing section 11-i) and the signal processing by the receiving apparatus 20 (the signal processing section 22-i). For example, the value may be determined such that the output intervals of the counter 223 become sufficiently equal, that is to say, the clock frequency output from the counter 223 becomes constant. Preferably, the value may be determined to be an integer multiple of the basic unit or the minimum unit of data in the tributary signal.

The PLL circuit (frequency-multiplier-by-N circuit) 224 is an example of a frequency-multiplier-by-N circuit which multiplies the output (clock frequency) of the counter 223 by N. The clock, which is multiplied by N, corresponds to a clock recovered from the clock (the first clock frequency) of the original tributary signal #i, and is given to the frequency transfer section 222.

That is to say, the above-described counter 223 and the PLL circuit 224 are used as an example of a clock recovery section, which recovers the clock (first clock frequency) of the original tributary signal on the basis of the cycle obtained by counting the data obtained by the signal processing section 221 at certain intervals.

The frequency transfer section (performing the transmission processing) 222 transfers clock from the clock of the tributary signal having been subjected to signal processing by the signal processing section 221 to the recovered clock from the PLL circuit 224 as an example of transmission processing, and transmits the signal having the transferred clock to the tributary apparatus #i′.

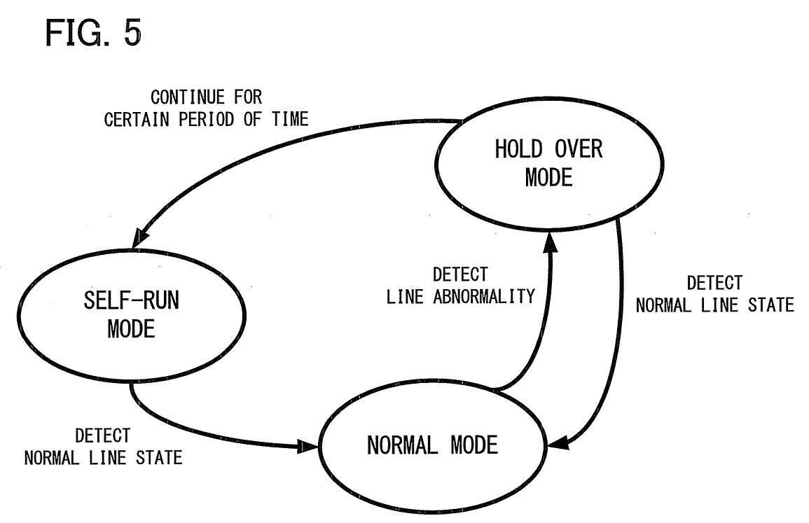

In this regard, in order to handle the case where data in the tributary-signal is not correctly detected because of line abnormality, etc., and the output of the counter 223 becomes abnormal, the PLL circuit 224 has a function of holding the previous value (hold over), and a selector (SEL) 226 (self-run mode) as an example of a selection section which switches input thereof to the internal oscillator 225. The signal processing section 221 detects whether the line state is normal or abnormal, and the PLL circuit 224 switches the operation mode on the basis of the detection information. FIG. 5 illustrates an example of operation-mode transition of the PLL circuit 224.

As shown in FIG. 5, the PLL circuit 224, for example, selects to use the output of the counter 223 as input by the selector 226 in a normal mode. In the normal mode, when the signal processing section 221 detects line abnormality (line disconnection, etc.), the PLL circuit 224 proceeds to a holdover state.

That is to say, the PLL circuit 224 holds the clock frequency obtained by the counter 223, and when the signal processing section 221 fails to obtain data normally, the PLL circuit 224 multiplies the held clock frequency by N so as to recover the clock frequency of the data in the original tributary signal.

If the holdover state continues for a certain period of time, the PLL circuit 224 controls the selector 226 to select the output of the internal oscillator 225 as input (to be multiplied by N) (self-run mode). In this regard, the internal oscillator 225 generates a clock frequency corresponding to the count frequency of the counter 223.

If the signal processing section 221 detects a normal line state before a lapse of a certain period of time, the PLL circuit 224 returns to a normal mode. Also, if a normal line state is detected in the self-run mode, the PLL circuit 224 proceeds to the normal mode, and selects the output of the counter 223 as input by the selector 226.

In this manner, by the PLL circuit 224 having a holdover state and a self-run mode, even when the signal processing section 221 fails to obtain data normally, it is possible to prevent the discontinuation of clock supply to the frequency transfer section 222. Accordingly, it is possible to prevent the occurrence of abnormality, such as a communication breakdown.

Operation Example

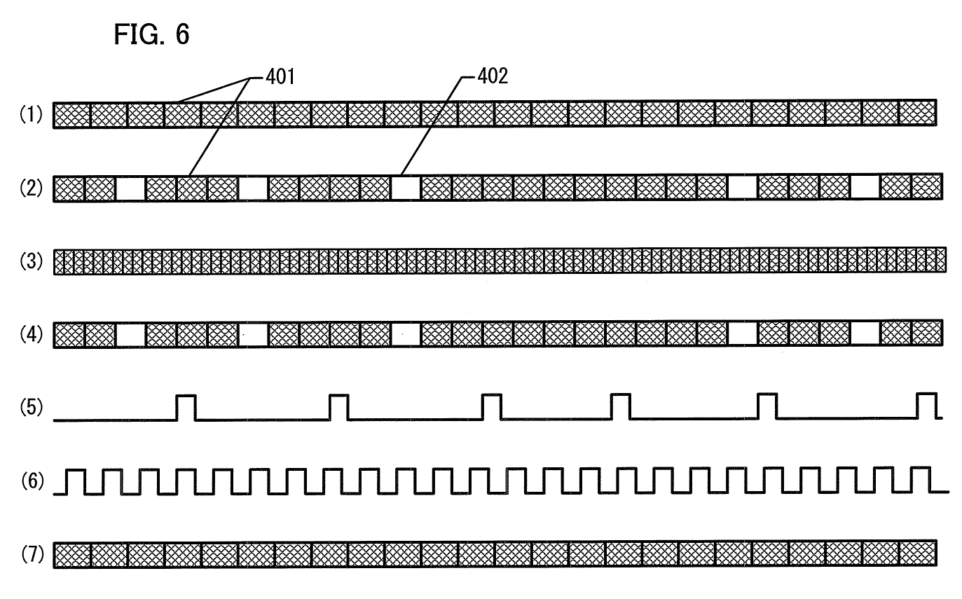

In the following, a description will be given of an example of operation of the communication system in the present embodiment with reference to a timing chart shown in FIG. 6. In this regard, a chart (1) shown in FIG. 6 shows an example of a tributary signal input into the signal processing section 11-i of the transmission apparatus 10, a chart (2) shown in FIG. 6 shows an example of a tributary signal having been subjected to signal processing by the signal processing section 11-i, and a chart (3) shown in FIG. 6 shows an example of a signal having subjected to time-division multiplexing by the multiplexing section 12. Also, a chart (4) shown in FIG. 6 shows an example of a tributary signal (input signal of the signal processing section 221) separated by the demultiplexing section 21 of the receiving apparatus 20, a chart (5) shown in FIG. 6 shows an example of an output of the counter 223, a chart (6) shown in FIG. 6 shows an example of an output of the PLL circuit 224, and a chart (7) shown in FIG. 6 shows an example of an output of the frequency transfer section 222.

Also, the marks (1) to (7) shown in FIG. 1 and FIG. 3 correspond to the chart (1) to (7) shown in FIG. 6 respectively.

First, when the transmission apparatus 10 receives the tributary signal as shown in the chart (1) from the transmission-source tributary apparatus #i, the corresponding signal processing section 11-i performs the above-described signal processing on the received tributary signal.

As a result, the tributary signal after the signal processing becomes a signal produced by mixing, in a predetermined format, the original tributary signal data 401, which is shown by being cross-hatched, and the data 402 added by the signal processing section 11-i, such as overhead information, padding, etc., which is shown by space, as shown in the chart (2).

Next, each tributary signal having been subjected to such signal processing is time-division multiplexed by the demultiplexing section 12 to become the time-division multiplexed signal as shown in the chart (3), and is transmitted onto the transmission line 30. The data 402 is not shown in the chart (3), but the chart (3) includes the data 402 as being multiplexed the signal in the chart (2).

On the other hand, the receiving apparatus 20 separates the time-division multiplexed signal received through the transmission line 30 into each tributary signal before the multiplexing. Each separated tributary signal is a signal as shown in the chart (4), for example, and is received by the signal processing section 221 of the signal-processing/clock-recovery sections 22-i.

The signal processing section 221 deletes the data 402 added by the signal processing section 11-i of the transmission apparatus 10, such as overhead information, padding, etc., by performing the above-described signal processing on the tributary signal shown in the chart (4) so as to reproduce the original tributary signal data.

The counter 223 performs counting each time when data of the original tributary signal is detected, and outputs a clock each N counts to the PLL circuit 224 as shown in the chart (5). In this regard, the chart (5) shows the case of N=4. That is to say, a clock is given to the PLL circuit 224 every four times of detection of data in the original tributary signal.

The PLL circuit 224 generates a clock as shown in the chart (6) by multiplying the frequency of the output of the counter 223 by N. That is to say, a clock in synchronous with the clock of the original tributary signal data 401 is generated (recovered).

The recovered clock is given to the frequency transfer section 222. The frequency transfer section 222 performs clock transfer on the tributary signal having been subjected to the signal processing by the signal processing section 221 to the recovered clock given from the PLL circuit 224.

Thereby, as shown in the chart (7), the receiving apparatus 20 can transmit the tributary signal having been subjected to the signal processing by the signal processing section 221 to the tributary apparatus #i′ at the equal intervals (at a clock in synchronous with the recovered clock) of the original tributary signal data 401 received by the transmission apparatus 10.

That is to say, it becomes possible to transparently transmit the clock of the tributary signal from the transmission-source tributary apparatus #i to the transmission-destination tributary apparatus #i′. Thus, it is not necessary to change an IFG in order to absorb the frequency deviation among tributary signals.

### [2] Others

In this regard, in the above-described embodiment, it is not necessary that the data whose clock is to be recovered is the data of the tributary signal which is time-division multiplexed by the transmission apparatus 10, and is time-division demultiplexed by the receiving apparatus 20. The above-described embodiment is effective for such data as original data whose clock frequency is eliminated by predetermined signal processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A clock recovery apparatus for performing clock recovery from a received signal, the clock recovery apparatus receiving a signal transmitted from a transmission apparatus converting a signal having a first signal-format with a first clock frequency into a signal having a second signal-format and transmitting the signal to the clock recovery apparatus in accordance with a second clock frequency, the clock recovery apparatus comprising:
a signal processing section for converting the received signal into a signal having the first signal-format; and
a clock recovery section for recovering the first clock frequency on a basis of a cycle produced by counting data of the signal having the first signal-format obtained by the signal processing section in a certain number.

2. The clock recovery apparatus according to claim 1,
wherein the received signal by the signal processing section has the second signal-format, includes a tributary signal time-division multiplexed in the transmission apparatus, the received signal being time-division demultiplexed at a pre-stage of the signal processing section.

3. The clock recovery apparatus according to claim 1, wherein the clock recovery section comprises:
an N-cycle counter for generating a clock for every N counts, wherein N is an integer of 2 or more; and
a frequency-multiplier-by-N circuit for recovering a clock having the first clock frequency by multiplying a frequency of the clock generated by the N-cycle counter by N.

4. The clock recovery apparatus according to claim 3, wherein the frequency-multiplier-by-N circuit holds the frequency of the clock generated by the N-cycle counter, and multiplies the held frequency of the clock by N so as to recover the clock having the first clock frequency in a case where the signal processing section fails to obtain the signal having the first signal-format normally.

5. The clock recovery apparatus according to claim 4, further comprising:
an internal oscillator for generating a clock having a frequency corresponding to the count cycle generated by the N-cycle counter,
wherein the frequency-multiplier-by-N circuit multiples the frequency of the clock generated by the internal oscillator by N so as to recover the clock having the first clock frequency in case where the signal processing section fails to obtain the signal having the first signal-format normally for a certain period of time.

6. A second transmission apparatus for performing clock recovery from a received signal, the second transmission apparatus receiving a signal transmitted from a first transmission apparatus converting a signal having a first signal-format with a first clock frequency into a signal having a second signal-format and transmitting the signal to the second transmission apparatus in accordance with a second clock frequency, the transmission apparatus comprising:
a signal processing section for converting the received signal into a signal having the first signal-format;
a clock recovery section for recovering the first clock frequency on a basis of a cycle produced by counting data of the signal having the first signal-format obtained by the signal processing section in a certain number and for generating a transmission clock frequency; and
a transmission processing section for performing transmission processing of the signal having the first signal-format obtained by the signal processing section in accordance with the transmission clock frequency generated by the clock recovery section.

7. The transmission apparatus according to claim 6,
wherein the received signal by the signal processing section has the second signal-format, includes a tributary signal time-division multiplexed in the first transmission apparatus, the received signal being time-division demultiplexed at a pre-stage of the signal processing section.

8. The transmission apparatus according to claim 6, wherein the clock recovery section comprises:
an N-cycle counter for generating a clock for every N counts, wherein N is an integer of 2 or more; and
a frequency-multiplier-by-N circuit for recovering a clock having the first clock frequency by multiplying a frequency of the clock generated by the N-cycle counter by N.

9. The transmission apparatus according to claim 8, wherein the frequency-multiplier-by-N circuit holds the frequency of the clock generated by the N-cycle counter, and multiplies the held frequency of the clock by N so as to recover the clock having the first clock frequency in a case where the signal processing section fails to obtain the signal having the first signal-format normally.

10. The transmission apparatus according to claim 9, further comprising:
an internal oscillator for generating a clock having a frequency corresponding to the count cycle generated by the N-cycle counter,
wherein the frequency-multiplier-by-N circuit multiples the frequency of the clock generated by the internal oscillator by N so as to recover the clock having the first clock frequency in case where the signal processing section fails to obtain the signal having the first signal-format normally for a certain period of time.

11. A clock recovery method of a transmission apparatus for performing clock recovery from a received signal, the transmission apparatus receiving a signal transmitted from the other transmission apparatus converting a signal having a first signal-format with a first clock frequency into a signal having a second signal-format and transmitting the signal to the transmission apparatus in accordance with a second clock frequency, the clock recovery method comprising:
a signal processing step of converting the received signal into a signal having the first signal-format; and
a clock recovery step of recovering the first clock frequency on a basis of a cycle produced by counting data of the signal having the first signal-format obtained by the signal processing step in a certain number.
